(19) United States
(12) Patent Application Publication
(10) Pub. No.: US 2008/0136937 A1
(43) Pub. Date: Jun. 12, 2008

(54) IMAGE PROCESSING APPARATUS, IMAGE PROCESSING METHOD, AND PROGRAM

(75) Inventor: Sho MURAKOSHI, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/938,526

(22) Filed: Nov. 12, 2007

(30) Foreign Application Priority Data
Dec. 7, 2006 (JP) 2006-330538

(51) Int. Cl. H04N 5/76

(52) U.S. Cl. 348/231.2

(57) ABSTRACT

An image processing apparatus includes a feature extracting unit for extracting features of images forming video content, a selection unit for selecting a plurality of images from the images forming the video content on the basis of the features extracted by the feature extracting unit, an image processing unit for performing special effects on the images selected by the selection unit, and a display control unit for sequentially displaying, as information concerning the video content, in units of a predetermined time, the images on which the special effects have been performed by the image processing unit.

### CROSS REFERENCES TO RELATED APPLICATIONS

The present invention contains subject matter related to Japanese Patent Application JP 2006-330538 filed in the Japanese Patent Office on Dec. 7, 2006, the entire contents of which are incorporated herein by reference.

### BACKGROUND OF THE INVENTION

1. Field of the Invention

The present invention relates to image processing apparatuses, image processing methods, and programs, and in particular, to an image processing apparatus, image processing method, and program for enabling a user to efficiently confirm the details of video content in a form allowing the user to feel interested in the video content.

2. Description of the Related Art

In a case of the related art, with picture recording apparatuses such as hard disk recorders, by displaying thumbnails showing the details of pieces of video content together with titles of the pieces of video content, convenience of a user is enhanced when the user wishes to select a piece of video content to be played back from pieces of recorded video content. As thumbnails, images (still images) obtained by reducing one-frame images displayed when video content is played back are used.

Japanese Unexamined Patent Application Publication No. 2005-354664 discloses a technology in which, by displaying, in a storyboard window, thumbnails at times corresponding to each of clips, not only details of an entire program, but also the details of each clip can be easily confirmed by a user.

### SUMMARY OF THE INVENTION

An image displayed as a thumbnail is an image of only one frame from a very large number of images forming video content, and it is common that selection of the image of the one frame is performed in accordance with a simple algorithm such as selection of a leading image of video content. Thus, displayed thumbnails may not appropriately show the details of video content.

For example, when the same broadcast program, such as a serial drama, is recorded by a user every week, as information of the recorded drama at different times, images that are each obtained by reducing a title screen of the drama may be typically displayed in a thumbnail form.

The present invention has been made in view of the above circumstances. It is desirable to enable a user to efficiently confirm the details of video content in a form allowing the user to feel interested in the video content.

An image processing apparatus according to an embodiment of the present invention includes feature extracting means for extracting features of images forming video content, selection means for selecting a plurality of images from the images forming the video content on the basis of the features extracted by the feature extracting means, image processing means for performing special effects on the images selected by the selection means, and display control means for sequentially displaying, as information concerning the video content, in units of a predetermined time, the images on which the special effects have been performed by the image processing means.

The image processing means may further include recording means for recording the video content. In this case, the display control means sequentially may display, as information displayed in a list of pieces of the information concerning the video content recorded in the recording means, in the units of the predetermined time, the images on which the special effects have been performed by the image processing means.

On the basis of the features extracted by the feature extracting means, the selection means may select, as the plurality of images, images that are at separate positions when the images forming the video content are arranged in a display order.

An image processing method or program according to another embodiment of the present invention includes the steps of extracting features of images forming video content, selecting a plurality of images from the images forming the video content on the basis of the extracted features, performing special effects on the selected images, and sequentially displaying, as information concerning the video content, in units of a predetermined time, the images on which the special effects have been performed.

According to an embodiment of the present invention, features of images forming video content are extracted, and, on the basis of the extracted features, a plurality of images are selected from the images forming the video content. In addition, special effects are performed on the selected images, and the images on which the special effects have been performed are sequentially displayed as information concerning the video content in units of a predetermined time.

According to an embodiment of the present invention, a user can efficiently confirm the details of video content in a form allowing the user to feel interested in the video content.

### BRIEF DESCRIPTION OF THE DRAWINGS

FIG. 1 is an illustration showing an image processing apparatus according to an embodiment of the present invention;

FIG. 2 is an illustration showing a menu screen and an example of a title list;

FIG. 3 is an illustration showing an example of generation of reduced representative video content;

FIG. 4 is a block diagram showing an example of a hardware configuration of the image processing apparatus;

FIG. 5 is a block diagram showing an example of a functional configuration of the image processing apparatus;

FIG. 6 is a flowchart illustrating a reduced-representative-video-content generating process of the image processing apparatus; and

FIG. 7 is a flowchart illustrating a reduced-representative-video display process of the image processing apparatus.

### DESCRIPTION OF THE PREFERRED EMBODIMENTS

Before describing an embodiment of the present invention, the correspondence between the features of the claims and the specific elements disclosed in an embodiment of the present invention is discussed below. This description is intended to assure that an embodiment supporting the claimed invention is described in this specification. Thus, even if an element in the following embodiment is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

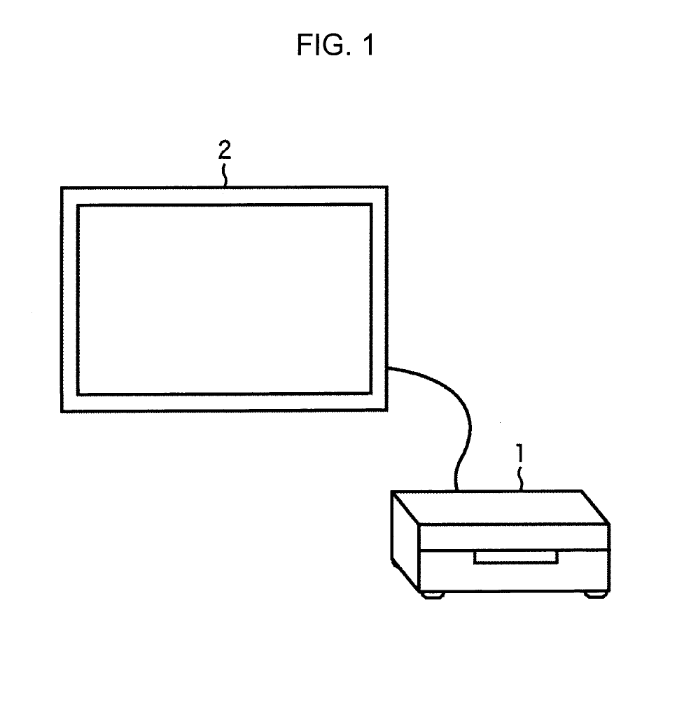

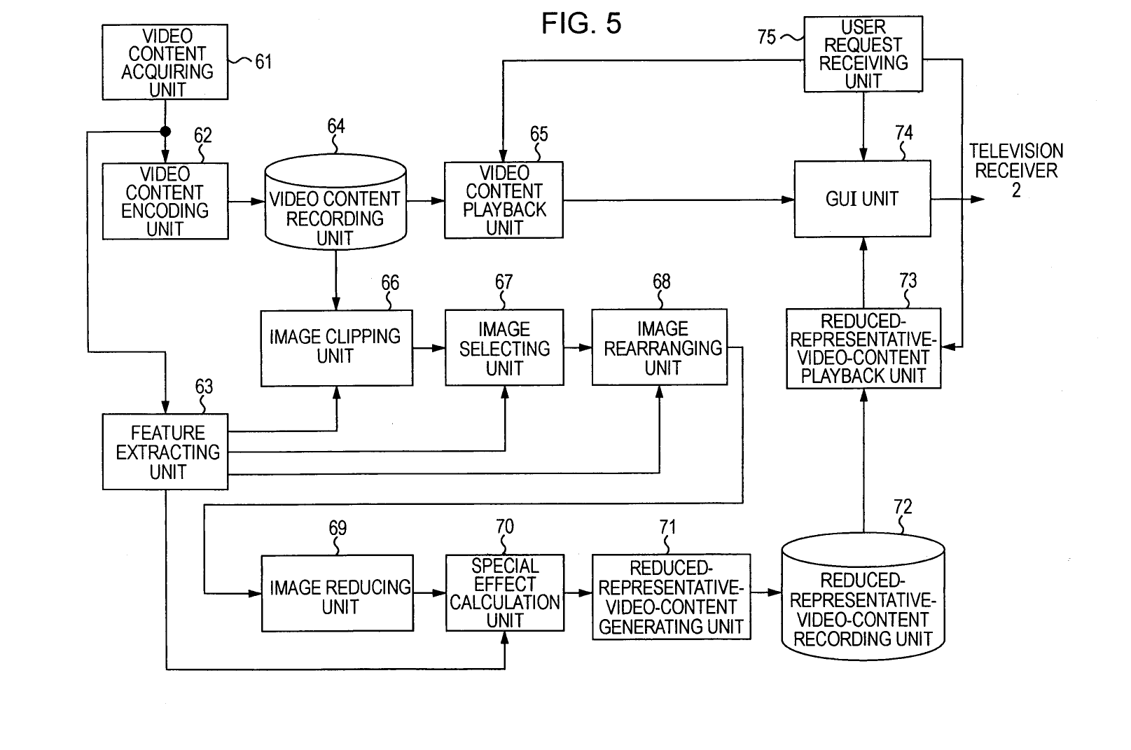

An image processing apparatus (e.g., the image processing apparatus 1 shown in FIG. 1) according to an embodiment of the present invention includes feature extracting means (e.g., the feature extracting unit 63 shown in FIG. 5) for extracting features of images forming video content, selection means (e.g., the image clipping unit 66 shown in FIG. 5) for selecting a plurality of images from the images forming the video content on the basis of the features extracted by the feature extracting means, image processing means (e.g., the special effect calculation unit 70 shown in FIG. 5) for performing special effects on the images selected by the selection means, and display control means (e.g., the reduced-representative-video-content playback unit 73 shown in FIG. 5) for sequentially displaying, as information concerning the video content, in units of a predetermined time, the images on which the special effects have been performed by the image processing means.

The image processing apparatus may further include recording means (e.g., the video content recording unit 64 shown in FIG. 5) for recording the video content.

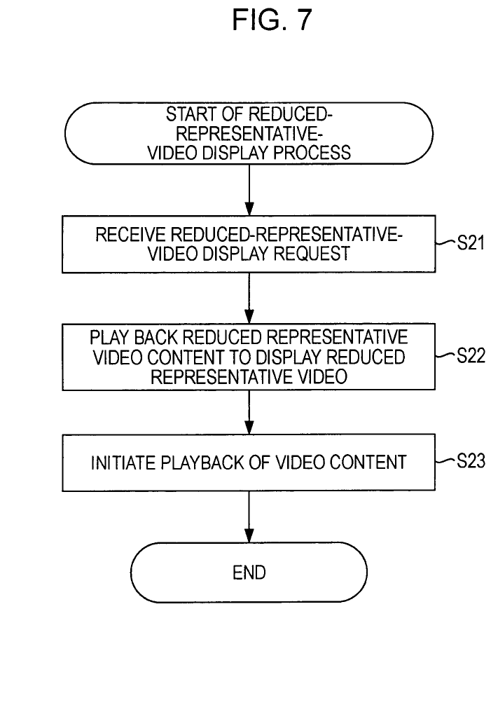

An image processing method or program according to another embodiment of the present invention includes the steps (e.g., step S22 shown in FIG. 7) of extracting features of images forming video content, selecting a plurality of images from the images forming the video content on the basis of the extracted features, performing special effects on the selected images, and sequentially displaying, as information concerning the video content, in units of a predetermined time, the images on which the special effects have been performed.

An embodiment of the present invention is described below with reference to the accompanying drawings.

FIG. 1 is an illustration showing an image processing apparatus 1 according to an embodiment of the present invention.

As shown in FIG. 1, a television receiver 2 is connected to the image processing apparatus 1 by a cable. The image processing apparatus 1 includes a recording medium such as a hard disk, and records video content such as programs provided through digital television broadcasting or Internet broadcasting. In other words, a signal from an antenna, or the like, is supplied to the image processing apparatus 1. In response to user's operations performed with a remote controller or the like, the image processing apparatus 1 plays back recorded video content, and outputs video and sound of a program from the television receiver 2.

A piece of video content to be played back is selected by a user from a title list displayed by the image processing apparatus 1. The title list is a list of information concerning pieces of video content recorded in the image processing apparatus 1, and can be displayed from a menu screen for performing integrated management of various functions of the image processing apparatus 1.

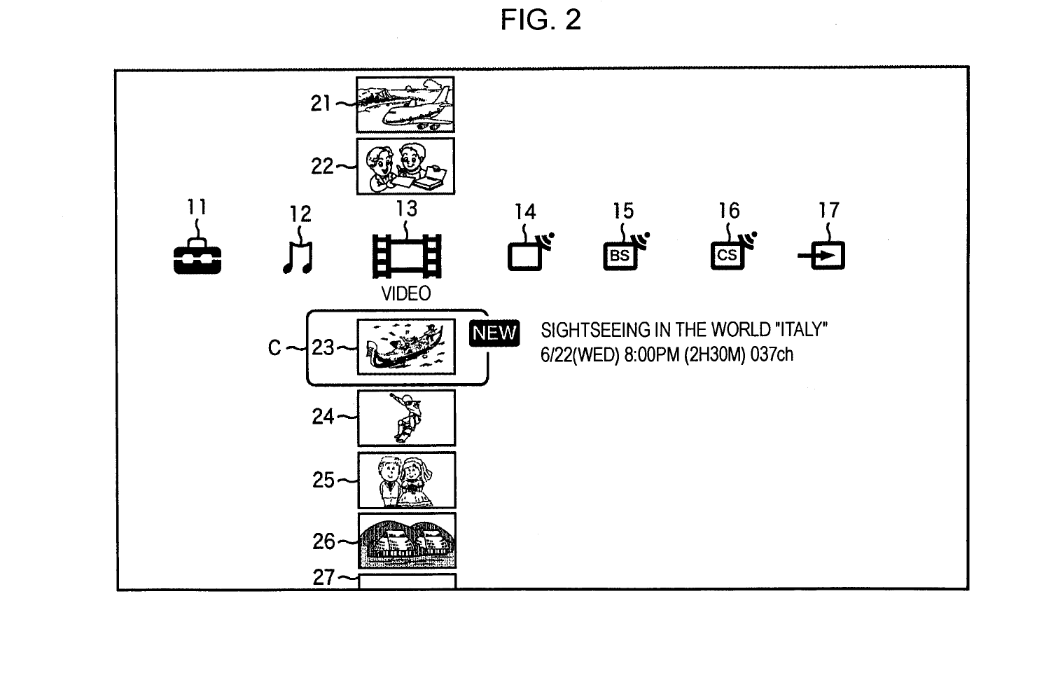

FIG. 2 is an illustration showing the menu screen and an example of the title list.

As shown in FIG. 2, on the menu screen, icons 11 to 17 indicating functions are displayed so as to be horizontally arranged.

In response to right and left operations of the user, the icons 11 to 17 are displayed so that the entirety thereof is simultaneously moved. When the user presses a left button once, the icons 11 to 17 are displayed so that each icon is moved to the right by one icon. Conversely, when the user presses a right button once, the icons 11 to 17 are displayed so that each icon is moved to the left by one icon. In accordance with movement of display positions of the icons 11 to 17, an icon that is moved out of a display range disappears, and a new icon that is moved into the display range is displayed.

In accordance with the movement of the display positions of the icons 11 to 17, functions of interest are also switched so that a function indicated by a new icon displayed at the display position of the icon 13 in FIG. 2 is used as a function of interest.

The icon 11 indicates a “Setting” function that is selected when various settings are performed. The icon 12 indicates a “Music” function that is selected when music is played back. The icon 13 is a “Video” function that is selected when playback of recorded video content, or the like, is performed.

The icon 14 indicates a “Terrestrial digital television broadcasting” function, and the icon 15 indicates a “BS (broadcasting satellite) digital television broadcasting” function. The icon 16 indicates a “CS (communications satellite) digital television broadcasting” function. The icon 17 indicates an “External device” function that is selected when setting and operation of an external device connected to the image processing apparatus 1 are performed.

The example shown in FIG. 2 shows a state in which, among the “Setting”, “Music”, “Video”, “Terrestrial digital television broadcasting”, “ES digital television broadcasting”, “CS digital television broadcasting”, and “External device” functions, the “Video” function is paid attention to by the user, and the title list is displayed. The icon 13 indicating the “Video” function is displayed in a color different from colors of the other icons.

In the title list in FIG. 2, shown thumbnails 21 to 27 indicating pieces of recorded video content are vertically arranged on the basis of the position of the icon 13 indicating “Video”. The thumbnails 21 and 22 are displayed above the icon 13, and the thumbnails 23 to 27 are displayed below the icon 13. The thumbnail 27 is only partially displayed since part of the thumbnail 27 is out of the display range. The above thumbnails are prepared for all the pieces of recorded video content, and the user can switch thumbnails to be displayed.

In addition, in the title list in FIG. 2, among the thumbnails 21 to 27, only on the right of the thumbnail 23 displayed in a form surrounded by a cursor C, information, such as a title, broadcast date and time, playback time, and channel number of a piece of video content indicated by the thumbnail 23, is also displayed.

In response to upward and downward operations of the user, the thumbnails 21 to 27 are displayed so that the entirety thereof is simultaneously moved. When the user presses an up button once, the thumbnails 21 to 27 are displayed so that each thumbnail is downwardly moved by one thumbnail. Conversely, when the user presses a down button once, the thumbnails 21 to 27 are displayed so that each thumbnail is upwardly moved by one thumbnail. In accordance with the movement of the display positions of the thumbnails 21 to 27, a thumbnail that is moved out of the display range disappears, and a new thumbnail that is moved into the display range is displayed.

The position of the cursor C is fixed. On the right of a thumbnail displayed in a form surrounded by the cursor C in accordance with the movement of the display positions of the thumbnails 21 to 27, information, such as a title, broadcast date and time, playback time, and channel number of a piece of video content indicated by the thumbnail, is displayed.

When a different function, such as “Setting” or “Music”, is paid attention to, similarly, on the basis of the position of an icon indicating the function that is paid attention to, pieces of information representing content belonging to the function are vertically arranged for display.

In the image processing apparatus 1, each of the thumbnails displayed in the title list in the above manner is a thumbnail of video content (moving images) generated on the basis of still images of a plurality of frames clipped from the recorded original video content. Displayed contents of the thumbnails change with a lapse of time. Clipping of images forming the thumbnails displayed in the title list is performed on the basis of the result of extracting features of images forming the original video content.

Content for use in displaying thumbnails is hereinafter referred to as “reduced representative video content” meaning video content including images obtained by reducing representative images clipped from original video content, if necessary. Video that is displayed as a thumbnail in the title list by playing back “reduced representative video content” is hereinafter referred to as “reduced representative video”.

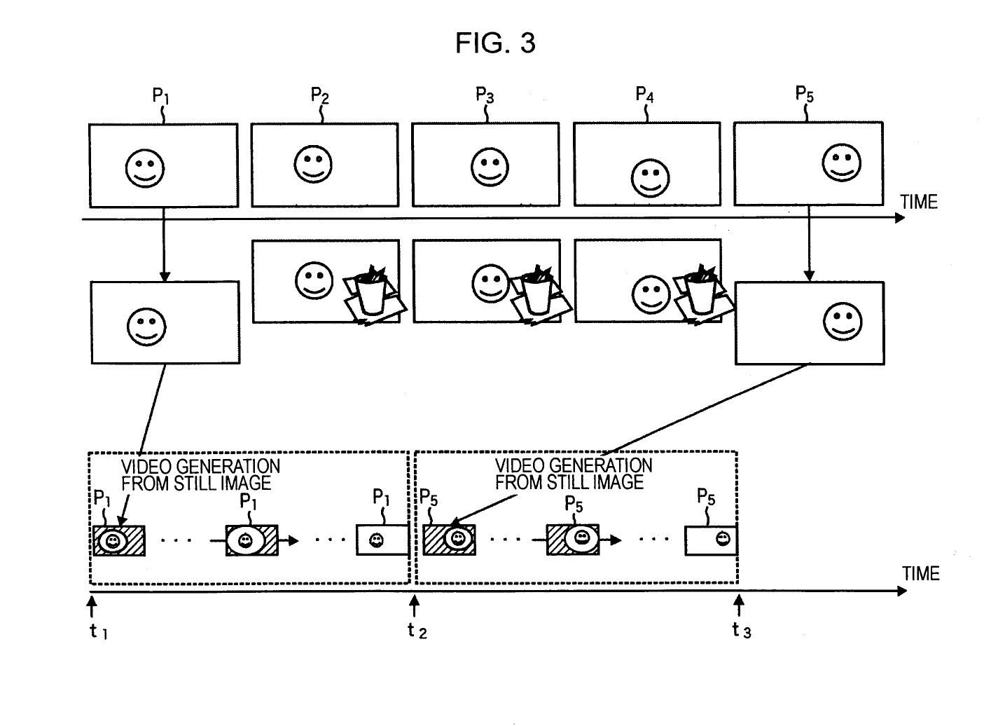

FIG. 3 is an illustration showing an example of generation of reduced representative video content.

Images P₁ to P₅ shown in an upper part of FIG. 3 are five-frame still images forming a piece of recorded video content. When the piece of recorded video content is played back, with its original state unchanged, images P₁ to P₅ are sequentially displayed at a predetermined frame rate such as 30 frames/second. The horizontal axis shown in FIG. 3 represents a time.

In the example shown in FIG. 3, images P₁ to P₅ have human faces. By playing back the original video content, the user can view video showing that a human face moves to the right.

When the reduced representative video content is generated, initially, feature extraction is performed for all images forming the original video content. Not only image features but also sound features may be extracted.

When the feature extraction is performed, a plurality of images are clipped on the basis of the result of the extraction. Details of features extracted and image clipping based on features are described later. In the example in FIG. 3, among images P₁ to P₅, images P₁ and P₅ are clipped. Image clipping is performed in such a manner that, for example, when images are arranged in a display order, images at separate positions are clipped.

The reduced representative video content is not such that images are sequentially displayed at predetermined time intervals. Instead, the reduced representative video content is such that images on which special effects have been performed are displayed in units of a predetermined time.

In the example in FIG. 3, reduced representative video content is generated by connecting images P₁ and P₅ in a form in which special effects are performed on both images so that image P₁ (clipped from the original video content) is displayed from time t₁ to time t₂, with a special effect performed on image P₁, and image P₅ (clipped from the original video content) is displayed from time t₂ to time t₃, with a special effect performed on image P₅.

Among the images P₁ and P₅ shown in a lower part of FIG. 3, hatched areas are, for example, black areas. In this example, in the special effect performed on each of images P₁ and P₅, an elliptic range including a human face gradually broadens.

A time from time t₁ to time t₃ is a time necessary for playing back the reduced representative video content once. During display of the thumbnails in the title list, playback of the reduced representative video content is repeated.

As described above, compared with the original video content, the reduced representative video content is generated in such a manner that video obtained by performing frame and temporal reduction is displayed.

Reduced representative video obtained by playing back the reduced representative video content is displayed as a thumbnail, whereby the amount of information can be increased compared with a case in which still images continue to be displayed. This allows the user to efficiently confirm details of recorded video content.

In addition, this can be realized in a form allowing the user to feel interested in the content by performing a special effect. For example, if a title screen of a program continues to be displayed, the user feels less interested.

A process of the image processing apparatus 1 for generating the reduced representative video content, as described above, and displaying a thumbnail on the basis of the generated reduced representative video content is described later with reference to flowcharts.

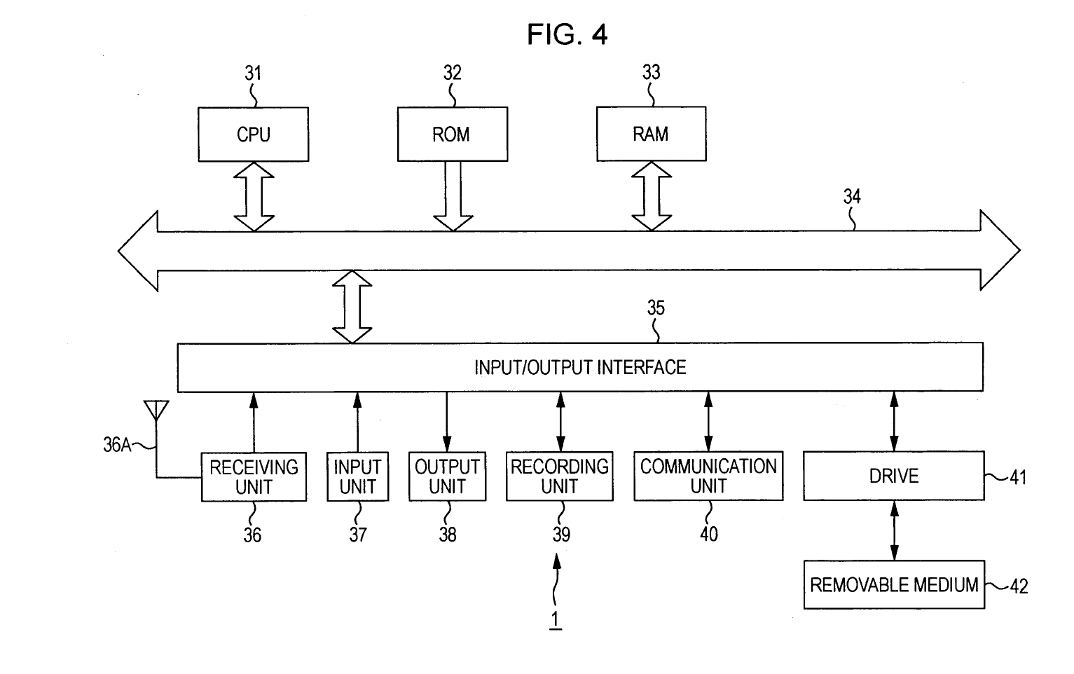

FIG. 4 is a block diagram showing an example of a hardware configuration of the image processing apparatus 1.

A CPU (central processing unit) 31 executes various processes in accordance with programs recorded in a ROM (read-only memory) 32 or a recording unit 39. A RAM (random access memory) 33 stores a program to be executed by the CPU 31 and data, if necessary. The CPU 31, the ROM 32, and the RAM 33 are connected to one another by a bus 34.

The CPU 31 connects to an input/output interface 35 via the bus 34. The input/output interface 35 connects to a receiving unit 36, an input unit 37, an output unit 38, the recording unit 39, a communication unit 40, and a drive 41.

The receiving unit 36 acquires an MPEG-TS (Moving Picture Experts Group-Transport Stream) by receiving and demodulating a broadcast wave signal from an antenna 36A. The receiving unit 36 extracts data (program's video, audio data) of a program to be recorded from the MPEG-TS, and outputs the extracted data to the recording unit 39 through the input/output interface 35.

The input unit 37 receives a signal from the remote controller, and outputs information representing a type of a user's operation to the CPU 31 through the input/output interface 35 and the bus 34. The CPU 31 performs various processes, such as playback of recorded video content, according to the information supplied from the input unit 37.

The output unit 38 allows the television receiver 2 to display video obtained such that the CPU 31 decodes the video content in a software manner.

The recording unit 39 includes, for example, a hard disk, and records various types of data such as the program to be executed by the CPU 31, and video content supplied from the receiving unit 36 through the input/output interface 35.

The communication unit 40 communicates with an external apparatus via a network such as the Internet or a local area network. Video content broadcast via the Internet may be received by the communication unit 40.

When a removable medium 42, such as a magnetic disk, an optical disc, a magneto-optical disc, or a semiconductor memory, is loaded, the drive 41 drives the removable medium 42, and acquires a program and data recorded in the removable medium 42. The acquired program and data are transferred and recorded in the recording unit 39, if necessary.

FIG. 5 is a block diagram showing an example of a functional configuration of the image processing apparatus 1. At least a part of the functional units shown in FIG. 5 is realized such that a predetermined program is executed by the CPU 31 shown in FIG. 4.

A video content acquiring unit 61 controls the receiving unit 36 to acquire video content to be recorded, and outputs the acquired video content to a video content encoding unit 62 and a feature extracting unit 63.

The video content encoding unit 62 performs processing, such as conversion into predetermined format data, on the video content supplied from the video content acquiring unit 61, if necessary, and outputs the obtained video content to a video content recording unit 64.

The feature extracting unit 63 extracts features of images forming the video content supplied from the video content acquiring unit 61. On the basis of the extraction, the feature extracting unit 63 controls image clipping (selection) by an image clipping unit 66, image selection by an image selecting unit 67, image rearrangement by an image rearranging unit 68, and processing for performing a special effect by a special effect calculation unit 70. The feature extraction is performed on audio, if necessary.

For example, the feature extracting unit 63 detects the occurrence of a scene change on the basis of a change in pixel value, and controls the image clipping unit 66 to clip an image immediately after the scene change. The feature extracting unit 63 also detects, as an interval of excitement, an interval in which the scene change occurs many times, and controls the image clipping unit 66 to clip images included in the interval of excitement at regular intervals. The feature extracting unit 63 also detects a human face by detecting a skin color area, and controls the image clipping unit 66 to clip images including human faces.

In addition, when the original video content is personal content obtained by photographing by the user with a video camera, the feature extracting unit 63 detects an image affected by a camera shake on the basis of pixel values, and controls the image selecting unit 67 to remove such an image from the images clipped by the image clipping unit 66. The feature extracting unit 63 also controls the image selecting unit 67 to remove images included in an interval corresponding to a short photographing time. The feature extracting unit 63 identifies subjects in images, and controls the image selecting unit 67 so that similar images are prevented from increasing.

When the original video content is broadcast content, the feature extracting unit 63 detects images each including tickers by performing character recognition, and controls the image selecting unit 67 to remove the images each including tickers from the images clipped by the image clipping unit 66. The feature extracting unit 63 also detects a CM (commercial message) interval on the basis of scene-change occurrence timing or the like, and controls the image selecting unit 67 to remove images included in the CM interval from the images clipped by the image clipping unit 66. When the original video content is a sports program, a result of a game may be displayed by using tickers. Images including such tickers are removed since, for a user who has not watched the program yet, it is not preferable that the images including the tickers be displayed in a thumbnail form, and images included in the CM interval are removed since the images included in the CM interval do not represent details of the video content.

The feature extracting unit 63 controls the image rearranging unit 68 to rearrange the images selected by the image selecting unit 67 in a time-series order. The feature extracting unit 63 also notes a feature value such as an excitement level calculated on the basis of a number of times the scene change occurs and sound volume, and controls the image rearranging unit 68 to rearrange the images in an order in which more feature values are extracted.

The feature extracting unit 63 determines a special effect type and an area to be initially displayed on the basis of the feature value, such as gradually displaying the entirety of an image after displaying only a partial area including a human face detected by face detection, and controls the special effect calculation unit 70 so that such a special effect is performed. Also, the feature extracting unit 63 distributes a time for one-time playback of reduced representative video content to each image according to a ratio of an excitement level so that an image clipped from an interval of a high excitement level is displayed for a long time, and controls the special effect calculation unit 70 to display, by the distributed time, an image on which a special effect is performed.

An image frame (vertical×horizontal) and the number of images that are simultaneously displayed may be controlled on the basis of a feature value. For example, images having a high excitement level are displayed in each frame of reduced representative video, and images having a low excitement level are simultaneously displayed in a plural frame form in one frame of reduced representative video.

When the video content is broadcast content, extraction of features by the feature extracting unit 63 may be performed by considering a program genre determined on the basis of EPG (electronic program guide) data.

For example, when the genre of video content is “Sports”, an interval in which images are displayed simultaneously with sound whose volume is large and whose frequency component is close to noise is extracted as an interval having a high excitement level. When the video content is a live broadcast of baseball, the interval extracted as having a high excitement level has a high possibility of being recognized as a home run scene compared with another interval. When the video content is a soccer program, the interval extracted as having a high excitement level has a high possibility of being recognized as a goal scene compared with another interval. In addition, when the video content is a golf program, the interval extracted as having a high excitement level has a high possibility of being recognized as a shot scene compared with another interval.

The video content recording unit 64 records the video content supplied from the video content encoding unit 62. The video content recorded in the video content recording unit 64 is read by a video content playback unit 65 and an image clipping unit 66, if necessary.

The video content playback unit 65 reads, from the video content recording unit 64, recorded video content whose playback is directed by the user, and outputs, to a GUI (graphical user interface) unit 74, a video signal obtained by playing back the read video content. For example, when predetermined video content is selected by the user from the title list, and its playback is directed, information concerning the video content whose playback is directed is supplied from a user request receiving unit 75 to the video content playback unit 65.

The image clipping unit 66 reads, from the video content recording unit 64, the original video content, which is a source for generating reduced representative video content, and clips a predetermined number of predetermined images from images forming the read video content under the control of the feature extracting unit 63. The image clipping unit 66 outputs the clipped images to the image selecting unit 67.

Image clipping may be simply performed at predetermined time intervals of 5 seconds, 10 seconds, 15 seconds, 30 seconds, or 1 minute, not on the basis of the features extracted by the feature extracting unit 63. In this case, for example, on the basis of a playback time of the entirety of the video content and a time for one-time playback of reduced representative video content, clipping time intervals are determined.

Under the control of the feature extracting unit 63, the image selecting unit 67 selects images for actual use in generating the reduced representative video content from the images supplied from the image clipping unit 66, and outputs the selected images to the image rearranging unit 68. As described above, images including tickers, images clipped from the CM interval are removed by the image selecting unit 67.

Under the control of the feature extracting unit 63, the image rearranging unit 68 rearranges the images supplied from the image selecting unit 67, and outputs the rearranged images to an image reducing unit 69 in a rearranged order.

The image reducing unit 69 reduces each of the images supplied from the image rearranging unit 68 into an image having an appropriate size for a thumbnail, and outputs the size-reduced images to the special effect calculation unit 70.

Under the control of the feature extracting unit 63, the special effect calculation unit 70 performs special effects, such as turning, reduction, enlargement, and movement of a partial area or the entirety, on the images supplied from the image reducing unit 69. The special effect calculation unit 70 outputs, to a reduced-representative-video-content generating unit 71, images obtained by performing the special effects.

The reduced-representative-video-content generating unit 71 generates the reduced representative video content by sequentially connecting the images on which the special effects have been performed by the special effect calculation unit 70 so as to be consecutively displayed, and outputs the generated reduced representative video content to a reduced-representative-video-content recording unit 72.

The reduced-representative-video-content recording unit 72 records the reduced representative video content supplied from the reduced-representative-video-content generating unit 71. The reduced representative video content recorded in the reduced-representative-video-content recording unit 72 is read by a reduced-representative-video-content playback unit 73 when the title list is displayed.

The reduced-representative-video-content playback unit 73 reads, from the reduced-representative-video-content recording unit 72, a piece of reduced representative video content for use in displaying reduced representative video in the title list, and outputs, to the GUI unit 74, a video signal obtained by playing back the read piece of reduced representative video content. For example, information indicating that display of the title list is directed by the user is supplied from the user request receiving unit 75 to the reduced-representative-video-content playback unit 73. The reduced-representative-video-content playback unit 73 simultaneously plays back plural pieces of reduced representative video content.

The GUI unit 74 displays the menu screen shown in FIG. 2, and displays a title list in response to a type of user's operation represented by the information supplied from the user request receiving unit 75. When the title list is displayed, the GUI unit 74 displays pieces of the reduced representative video content in an arranged manner on the basis of the video signal supplied from the reduced-representative-video-content playback unit 73, and displays a title, etc., of video content whose reduced representative video is surrounded by the cursor C. Information, such as a video content title, is recorded in a form associated with, for example, reduced representative video content, and is supplied to the GUI unit 74.

The GUI unit 74 displays video based on the video content on the basis of the video signal supplied from the video content playback unit 65 when playback of the video content is directed.

The user request receiving unit 75 receives a user's operation performed by using the remote controller, and outputs information representing a type of the received user's operation to the video content playback unit 65, the reduced-representative-video-content playback unit 73, and the GUI unit 74.

Next, processing of the image processing apparatus 1 having the above-described configuration is described below.

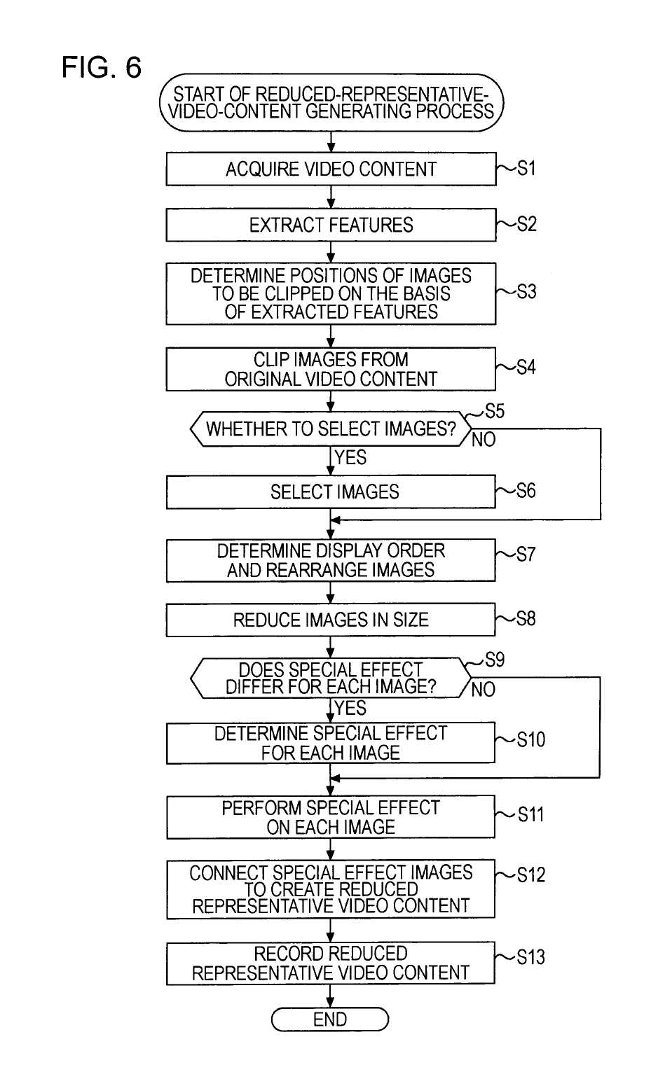

First, a reduced-representative-video-content generating process of the image processing apparatus 1 is described below with reference to the flowchart shown in FIG. 6.

In step S1, the video content acquiring unit 61 acquires video content to be recorded, and outputs the acquired video content to the video content encoding unit 62 and the feature extracting unit 63. Processing, such as conversion, is performed on the video content supplied to the video content encoding unit 62, if necessary. After that, the resultant video content is recorded in the video content recording unit 64.

In step S2, the feature extracting unit 63 extracts features of images forming the video content supplied from the video content acquiring unit 61.

In step S3, the feature extracting unit 63 determines the positions of images to be clipped on the basis of the extracted features. As described above, for example, positions immediately after a position at which a scene change is detected are determined as the positions of images to be clipped.

In step S4, the feature extracting unit 63 controls the image clipping unit 66 to perform image clipping. The image clipping unit 66 reads, from the video content recording unit 64, the original video content which is a source for generating the reduced representative video content, and clips images at positions designated by the feature extracting unit 63 from the images forming the read video content. The images clipped by the image clipping unit 66 are output to the image selecting unit 67.

In step S5, the feature extracting unit 63 determines whether to perform image selection. Here, for example, on the basis of the extracted features, when it is determined that the images clipped by the image clipping unit 66 include an image affected by a camera shake, or it is determined that the images clipped by the image clipping unit 66 include an image included in a CM interval, the feature extracting unit 63 determines to perform image selection.

If, in step S5, it is determined that image selection is to be performed, in step S6, the feature extracting unit 63 controls the image selecting unit 67 to select images for actual use in generating reduced representative video content. The images selected by the image selecting unit 67 are output to the image rearranging unit 68. Alternatively, if, in step S5, it is determined that image selection is not to be performed, step S6 is skipped over.

In step S7, the feature extracting unit 63 determines an image display order, and controls the image rearranging unit 68 to rearrange the images supplied from the image selecting unit 67. The rearranged images are output to the image reducing unit 69.

In step S8, the image reducing unit 69 reduces each of the images supplied from the image rearranging unit 68 into an image having an appropriate size for a thumbnail, and outputs the resultant images to the special effect calculation unit 70.

In step S9, the feature extracting unit 63 determines whether a type of a special effect to be performed differs for each image. For example, the feature extracting unit 63 manages features and types of special effects, with both associated with a plurality of patterns. When an image that is selected as a source image for generating reduced representative video content greatly differs in feature from other images, the feature extracting unit 63 determines that the type of the special effect differs for each image.

If, in step S9, it is determined that the type of the special effect differs for each image, in step S10, the feature extracting unit 63 determines a special effect to be performed for each image. If, in step S9, it is determined that the type of the special effect does not differ for each image, step S10 is skipped over.

In step S11, the feature extracting unit 63 controls the special effect calculation unit 70 to perform a special effect on each of the images supplied from the image reducing unit 69 to the special effect calculation unit 70. The resultant special effect images are output to the reduced-representative-video-content generating unit 71.

In step S12, the reduced-representative-video-content generating unit 71 generates reduced representative video content by sequentially connecting the special effect images obtained by the special effect calculation unit 70, and outputs the generated reduced representative video content to the reduced-representative-video-content recording unit 72.

In step S13, the reduced-representative-video-content recording unit 72 records the reduced representative video content supplied from the reduced-representative-video-content generating unit 71. The process finishes.

The above-described process is repeated whenever video content is acquired, whereby, in the reduced-representative-video-content recording unit 72, for all pieces of recorded video content, pieces of reduced representative video content for use in displaying reduced representative video are prepared.

Next, a reduced-representative-video display process of the image processing apparatus 1 is described below with reference to the flowchart shown in FIG. 7. This process is started, for example, when an operation of selecting the “Video” function is input in a state with the menu screen displayed.

In step S21, the user request receiving unit 75 receives a user's operation as a reduced-representative-video display request, and outputs, to the reduced-representative-video-content playback unit 73, information indicating that display of the title list is directed.

In step S22, the reduced-representative-video-content playback unit 73 reads reduced representative video content from the reduced-representative-video-content recording unit 72, and plays back the read reduced representative video content. A video signal obtained by playing back the reduced representative video content is output to the GUI unit 74, and, on the basis of the video signal, reduced representative video is displayed by the GUI unit 74.

This activates a state in which the title list shown in FIG. 2 is displayed. The user can select a piece of video content to be played back by viewing displayed reduced representative video. When a piece of video content to be played back is selected, the user request receiving unit 75 receives the reduced-representative-video display request, and outputs information concerning the piece of video content whose playback is requested to the video content playback unit 65.

In step S23, the video content playback unit 65 reads the piece of video content to be played back from the video content recording unit 64, and initiates playback of the read piece of video content. A video signal obtained by playing back the piece of video content is output to the GUI unit 74, and the GUI unit 74 displays video based on the piece of video content on the television receiver 2 instead of the menu screen.

The above-described processing makes it possible to provide the user with detailed information within a predetermined time, compared with a case in which an image obtained by reducing a one-frame image clipped from the original video content is continuously displayed.

In other words, in recorded video content, video including a plurality of images clipped from a scene having excitement can be viewed. The user can quickly know rough details of video content only from reduced representative video content without trying to play back the original video content.

In addition, images affected by a camera shake are not used for generating reduced representative video content, and consecutive images are not used for generating reduced representative video content. Thus, when images greatly affected by a camera shake are continuously displayed, the user can be prevented from becoming sick by viewing the displayed images.

In the foregoing, as shown in FIG. 2, the reduced representative video content is displayed in the title list. However, the reduced representative video content may be displayed in another screen such as a detailed screen of information concerning a piece of video content.

The above-described consecutive processing can be executed either by hardware or by software. When the consecutive processing is executed by software, a program forming the software is installed from a program recording medium into a computer built into dedicated hardware or, for example, a multi-purpose personal computer that can execute various functions by installing various programs.

The program executed by the computer is provided in a form recorded in the removable medium 42 (shown in FIG. 4), which is a package medium including, for example, a magnetic disk (including a flexible disk), an optical disc (such as a CD-ROM (compact-disc read-only memory) or DVD (digital versatile disc)), a magneto-optical disc, or a semiconductor memory, or via a wired or wireless transmission medium such as a local area network, the internet, or digital satellite broadcasting.

The program can be installed into the recording unit 39 through the input/output interface 35 by loading the removable medium 42 into the drive 41. In addition, the program can be received by the communication unit 40 through a wired or wireless transmission medium and can be installed into the recording unit 39. The program can also be installed in the ROM 32 or the recording unit 39 beforehand.

The program executed by the computer may be a program in which processing is performed in a time-series manner in accordance with the order described in this specification, or may be a program in which processing is performed in parallel or with necessary timing such as when a call is performed.

An embodiment of the present invention is not limited to the above-described embodiment, and may be variously modified without departing from the spirit and scope of the present invention.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
feature extracting means for extracting features of images forming video content;
selection means for selecting a plurality of images from the images forming the video content on the basis of the features extracted by the feature extracting means;
image processing means for performing special effects on the images selected by the selection means; and
display control means for sequentially displaying, as information concerning the video content, in units of a predetermined time, the images on which the special effects have been performed by the image processing means.

2. The image processing apparatus according to claim 1, further comprising recording means for recording the video content,
wherein the display control means sequentially displays, as information displayed in a list of pieces of the information concerning the video content recorded in the recording means, in the units of the predetermined time, the images on which the special effects have been performed by the image processing means.

3. The image processing apparatus according to claim 1, wherein, on the basis of the features extracted by the feature extracting means, the selection means selects, as the plurality of images, images that are at separate positions when the images forming the video content are arranged in a display order.

4. An image processing method comprising the steps of:
extracting features of images forming video content;
selecting a plurality of images from the images forming the video content on the basis of the extracted features;
performing special effects on the selected images; and
sequentially displaying, as information concerning the video content, in units of a predetermined time, the images on which the special effects have been performed.

5. A program for allowing a computer to execute processing including the steps of:
extracting features of images forming video content;
selecting a plurality of images from the images forming the video content on the basis of the extracted features;
performing special effects on the selected images; and
sequentially displaying, as information concerning the video content, in units of a predetermined time, the images on which the special effects have been performed.

6. An image processing apparatus comprising:
a feature extracting section extracting features of images forming video content;
a selection section selecting a plurality of images from the images forming the video content on the basis of the features extracted by the feature extracting section;
an image processing section performing special effects on the images selected by the selection section; and
a display control section sequentially displaying, as information concerning the video content, in units of a predetermined time, the images on which the special effects have been performed by the image processing section.
